(19) United States
(12) Patent Application Publication
(10) Pub. No.: US 2019/0050294 A1
(43) Pub. Date: Feb. 14, 2019

(54) CONTEXT AWARE SOFTWARE UPDATE FRAMEWORK FOR AUTONOMOUS VEHICLES

(71) Applicant: Intel Corporation, Santra Clara, CA (US)

(72) Inventors: Rony Ferzli, Chandler, AZ (US); Amit Aneja, Chandler, AZ (US)

(73) Assignee: Intel Corporation, Santa Clara, CA (US)

(21) Appl. No.: 15/858,121

(22) Filed: Dec. 29, 2017

(51) Int. Cl. G06F 11/14; G06F 8/65; H04L 29/08

(52) U.S. Cl. CPC G06F 11/1433; G06F 2201/865; H04L 67/34; G06F 8/65

(57) ABSTRACT

In one example a system to manage software updates for one or more devices on a vehicle comprises a communication interface to receive one or more software updates for the one or more devices on the vehicle, and a controller communicatively coupled to one or more devices and comprising processing circuitry to receive one or more software updates for at least one of the one or more devices, start a software update process for at least one of the one or more devices, detect a fault condition that corrupted the software update process, and in response to the fault condition, to implement a software update process fault protocol. Other examples may be described.

### BACKGROUND

The subject matter described herein relates generally to the field of electronic devices and more particularly to a context aware software update framework for autonomous vehicles.

Software updates are an important mechanism for any connected device. In the emerging autonomous vehicles market software update mechanisms are important because of the safety, security, reliability and predictable behavior expectations from autonomous vehicles. Accordingly, systems and methods to implement a context aware software may find utility, e.g., in managing components of autonomous vehicles.

### BRIEF DESCRIPTION OF THE DRAWINGS

The detailed description is described with reference to the accompanying figures.

FIG. 1 is a schematic illustration of an environment for a context aware software update framework for autonomous vehicles, in accordance with some examples.

FIG. 2 is a high-level schematic illustration of an exemplary architecture to implement context aware software update framework for autonomous vehicles in accordance with some examples.

FIGS. 3-5 are flowcharts illustrating operations in a method to implement a context aware software update framework for autonomous vehicles in accordance with some examples.

FIGS. 6-10 are schematic illustrations of electronic devices which may be adapted for use in a context aware software update framework for autonomous vehicles in accordance with some examples.

### DETAILED DESCRIPTION

Described herein are examples of a context aware software update framework for automated driving systems. In the following description, numerous specific details are set forth to provide a thorough understanding of various examples. However, it will be understood by those skilled in the art that the various examples may be practiced without the specific details. In other instances, well-known methods, procedures, components, and circuits have not been illustrated or described in detail so as not to obscure the particular examples.

As described above, it may be useful to provide a context aware software update framework for automated driving systems which may be used in vehicles. In one aspect described herein the framework may comprise a communication interface to receive one or more software updates for the one or more devices on the vehicle and a controller communicatively coupled to one or more devices and comprising processing circuitry to receive one or more software updates for at least one of the one or more devices, start a software update process for at least one of the one or more devices, detect a fault condition that corrupted the software update process, and in response to the fault condition, to implement a software update process fault protocol.

In another aspect the framework comprises a communication interface to receive one or more software updates for the one or more devices on the vehicle, and a controller communicatively coupled to the one or more devices and comprising processing circuitry to receive one or more software updates for at least one of the one or more devices, gather context data for the software updates for at least one of the one or more devices, determine whether the at least one of the one or more devices is interdependent with another device and implement one of a real-time update process or an offline update process.

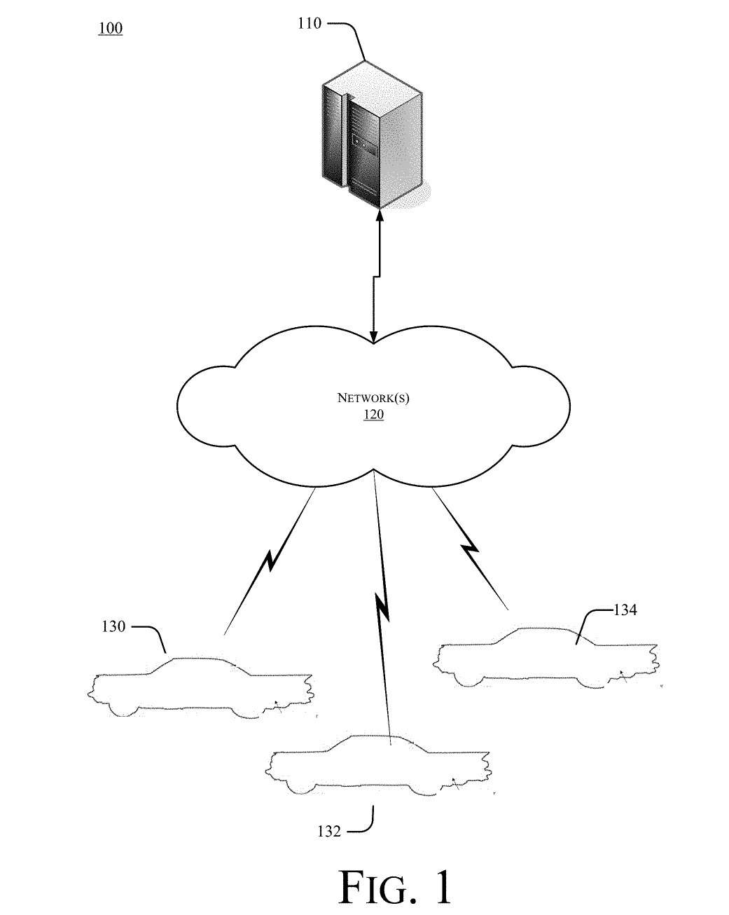

As used herein, the term vehicle should be construed broadly to include cars, trucks, buses or any form of road-based transportation. Further structural and operational details will be described with reference to FIGS. 1-10, below.

FIG. 1 is a schematic illustration of an environment for a context aware software update framework 100 for automated driving systems, in accordance with some examples. Referring to FIG. 1, in some examples the framework 100 comprises a cloud-based software update director 110 communicatively coupled to a communication network 120 capable of transmitting information from the update director 110 to one or more autonomous vehicles 130, 132, 134.

In some examples software update director 110 may comprise one or more processor-based devices, e.g., server(s) comprising computer-readable memory which stores software updates for one or more devices communicatively coupled to the one or more autonomous vehicles.

Network 120 may be embodied as a public communication network such as, e.g., the internet, or as a private communication network, such as a cellular network, or combinations thereof). In one or more examples, network 120 may operate in compliance with a Worldwide Interoperability for Microwave Access (WiMAX) standard or future generations of WiMAX, and in one particular example may be in compliance with an Institute for Electrical and Electronics Engineers 802.16-based standard (for example, IEEE 802.16e), or an IEEE 802.11-based standard (for example, IEEE 802.11 a/b/g/n standard), and so on. In one or more alternative examples, network 900 may be in compliance with a 3rd Generation Partnership Project Long Term Evolution (3GPP LTE), a 3GPP2 Air Interface Evolution (3GPP2 AIE) standard and/or a 3GPP LTE-Advanced standard. In general, network 900 may comprise any type of orthogonal-frequency-division-multiple-access-based (OFDMA-based) wireless network, for example, a WiMAX compliant network, a Wi-Fi Alliance Compliant Network, a digital subscriber-line-type (DSL-type) network, an asymmetric-digital-subscriber-line-type (ADSL-type) network, an Ultra-Wideband (UWB) compliant network, a Wireless Universal Serial Bus (USB) compliant network, a 4th Generation (4G) type network, and so on, and the scope of the claimed subject matter is not limited in these respects.

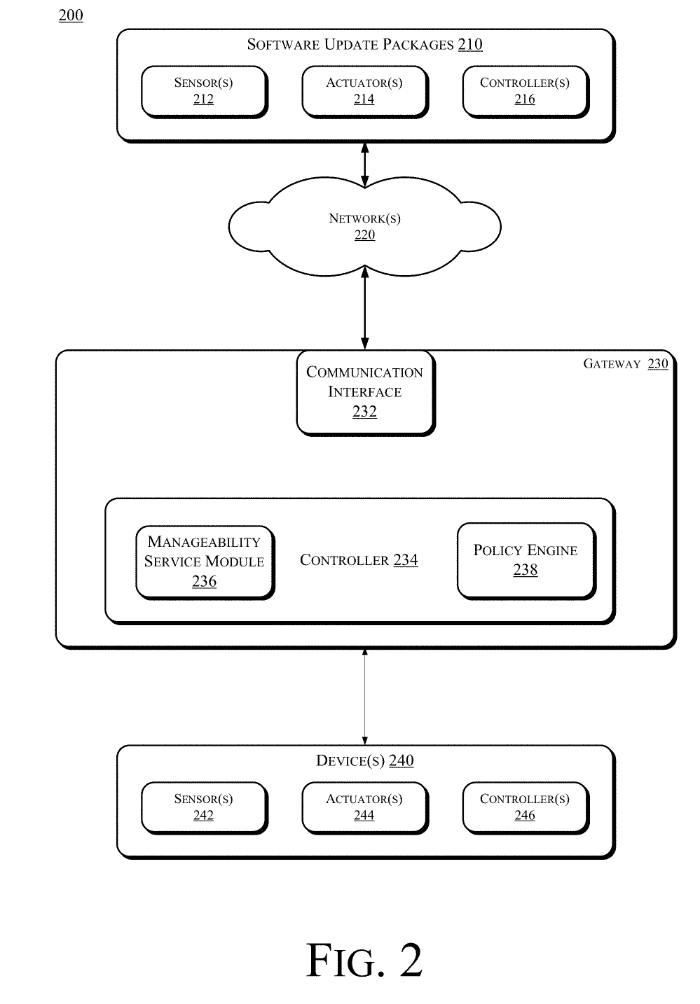

FIG. 2 is a high-level schematic illustration of an exemplary architecture 200 to implement context aware software update framework for autonomous vehicles in accordance with some examples. Referring to FIG. 2, in some examples the update director 110 may comprise one or more software update packages 210 which may comprise software and/or firmware for devices on the one or more autonomous vehicles. For example, the software update packages may comprise software and/or firmware for one or more sensors 212, actuators 214, or controllers 216. It will be appreciated that the software update packages may comprise software and/or firmware for other devices.

Software update packages 210 are communicatively coupled to one or gateways 230 via communication network(s) 220. Network(s) 220 may be embodied as a public communication network such as, e.g., the internet, or as a private communication network, such as a cellular network, or combinations thereof, as described above with reference to network 120.

Gateway 230 may be incorporated into or communicatively coupled to an autonomous vehicle and may comprise a communication interface 232 to manage communication via network 220, a controller 234, a manageability service module 236, and a policy engine 238. Communication interface 232 may comprise, or be coupled to, an RF transceiver which may implement a wireless connection via a protocol compliant with network 120, as described above.

Controller 234 may be embodied as general purpose processor such as an Intel® Core2 Duo® processor available from Intel Corporation, Santa Clara, Calif., USA. As used herein, the term “processor” means any type of computational element, such as but not limited to, a microprocessor, a microcontroller, a complex instruction set computing (CISC) microprocessor, a reduced instruction set (RISC) microprocessor, a very long instruction word (VLIW) microprocessor, or any other type of processor or processing circuit. Alternatively, controller 234 may be embodied as a low-power controller such as a field programmable gate array (FPGA) or the like. In some examples, controller 234 may comprise random access memory (RAM) and/or read-only memory (ROM). Controller 234 may comprise one or more applications including manageability service module 236 and policy engine 238 may be implemented as logic instructions executable on controller 234, e.g., as software or firmware, or may be reduced to hardwired logic circuits.

Controller 234 may be coupled to one or more devices 240 which comprise software and/or firmware which may need to be updated on a periodic basis. For example, devices 240 may include one or more sensors 242, actuators 244, or controllers 246.

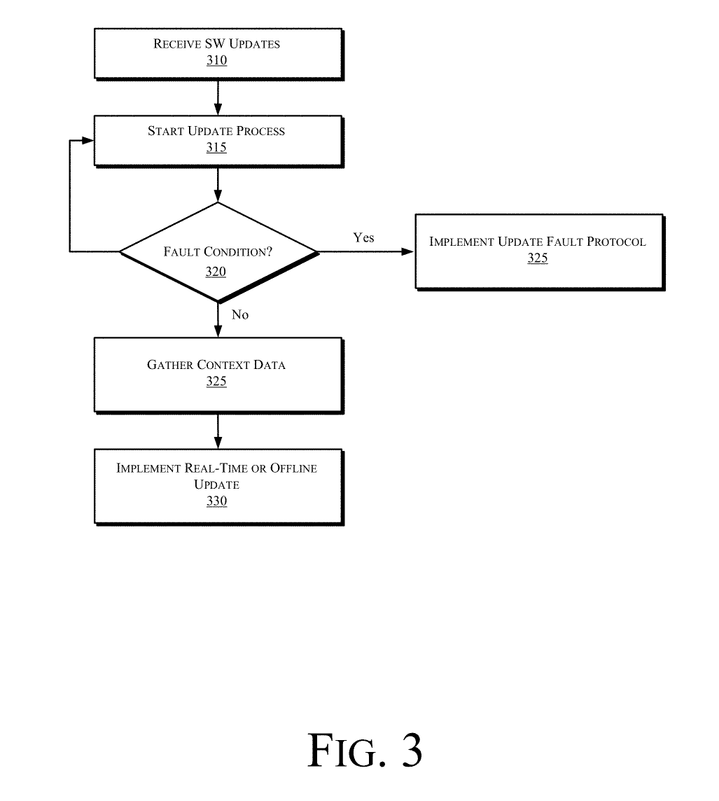

Having described various structural components of examples of a context-aware software update framework for autonomous vehicles, operations implemented by the system will be described with reference to FIGS. 3-5. Referring first to FIG. 3, at operation 310 the controller 234 receives one or more software updates for one or more devices coupled to the controller. For example, the controller 234 may receive software updates for one or more of the cameras 242, actuators 244, or sensors 246 communicatively coupled to the controller 234.

At operation 315 the controller 234 may start a software update process for one or more of the devices 240 coupled to the controller. If, at operation 315, the controller 234 determines that a fault condition occurs during the last software update execution cycle then control passes to operation 325 and the controller 234 implements an update fault protocol. By way of example, a fault condition may exist when a software update process fails due to a loss of power or another fault condition that prevents the software update process from completing successfully.

By contrast, if at operation 320 the controller 234 determines that a fault condition does not exist then control passes to operation 325 and the controller 234 implements a process to gather context data associated with the device(s) and/or the autonomous vehicle(s) that are to receive the software update and, operation 330, the controller implements a process to perform one of a real-time software update or an offline software update.

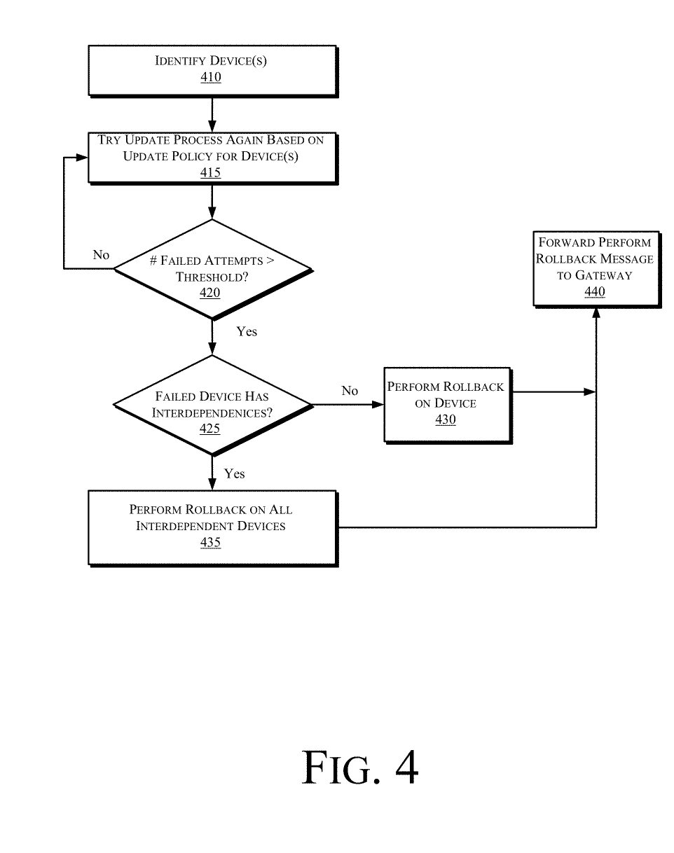

FIG. 4 is a flowchart illustrating operations in a method to implement the update fault protocol referenced in operation 325. Referring to FIG. 4, at operation 410 the controller 234 identifies the device(s) for which the software update process encountered a fault condition. At operation 415 the controller 234 may try the software update process again one or more times based on an update policy for the device(s) identified. For example, the update policy for the device may be stored in a local memory of the controller 234 and may include a threshold number of software updates attempts allowed for the device(s) before aborting the process.

If, at operation 420, the controller makes a determination that the number of failed attempts to update the software associated with the device does not exceed the threshold number of software updates, then control passes back to operation 415 and the controller 234 continues to attempt the software update process.

By contrast, if at operation 420 the controller makes a determination that number of failed attempts to update the software associated with the device does exceeds the threshold number of software update attempts, then control passes to operation 425 and the controller 234 determines whether the device receiving the software update has interdependencies with one or more other devices. By way of example, an actuator 244 which has incurred a fault in the software update process may be interdependent with one or more sensors 246, meaning that the actuator 244 and the sensor(s) 246 must have compatible software in order to cooperate. If, at operation 425, the controller determines that the failed device is not interdependent with other devices then control passes to operation 430 and the controller 234 performs a software rollback (i.e., a restore of the previous version of software) only on the device that incurred the fault condition. By contrast, if at operation 425, the controller 234 determines that the failed device is interdependent with one or more other devices then control passes to operation 435 and the controller 234 performs a software rollback on the device that incurred the fault condition and any interdependent device(s). At operation 440 the controller 234 forwards a message to the gateway 232 indicating that a software rollback was performed.

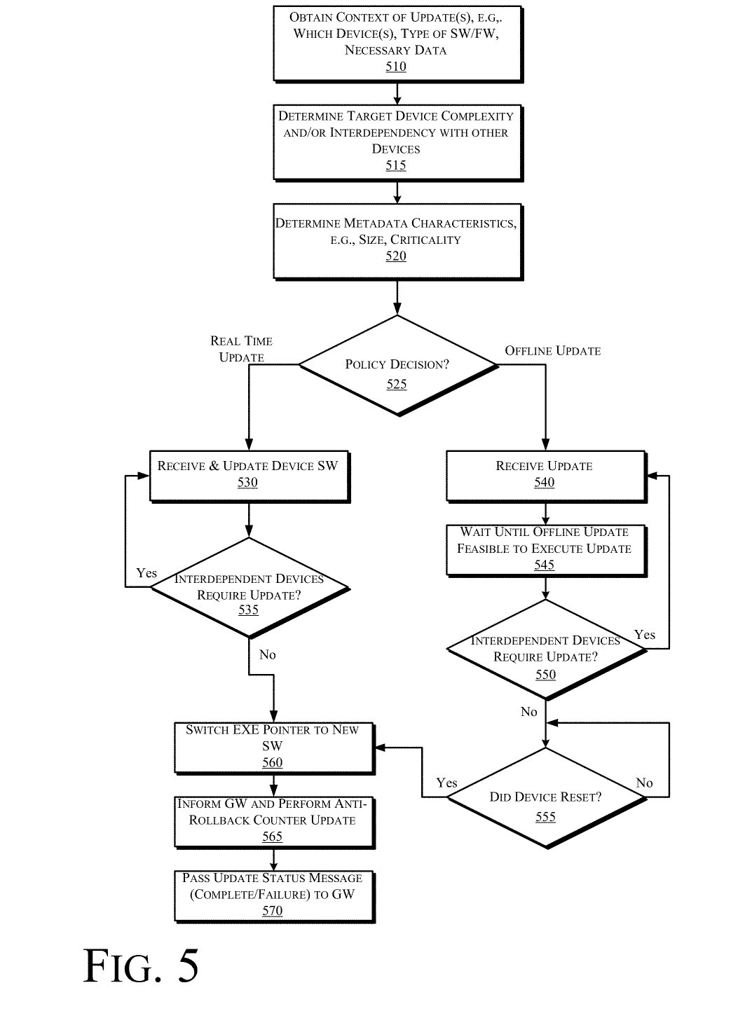

FIG. 5 is a flowchart illustrating operations in a method to implement the update protocols referenced in operation 330. Referring to FIG. 5, at operation 510 the controller obtains various context parameters for the software update(s) to the designated device(s). For example, the controller may determine the type of device(s), the type of software and/or firmware to be updated, and any other necessary data associated with the update process. At operation 515 the controller 234 may determine the target device complexity and/or any interdependencies the target device may have with other devices. At operation 520 the controller may determine other metadata characteristics associated with the software update, e.g., the size of the software update file(s), the criticality of the update, etc. In some examples software or firmware components may be classified into different levels that may require specific policies associated for updates. In some examples the operations 510-520 may be performed as a background/intermediate process which executes on the controller 234.

At operation 525 the controller implements a policy decision regarding whether the software update process should be performed as a real-time update process or an offline update process. In some examples the policy decision may be predetermined based on characteristics of the device(s) and/or the update(s). Alternatively, the policy decision may be made in real-time based on characteristics of the device(s) and/or the update(s) and/or one or more environmental characteristics.

If, at operation 525 the policy decision is to implement a real-time update then the controller executes operations 530-535 repeatedly until all interdependent devices have been updated. At operation 530 the controller 234 receives the software update and executes the update process on the target device. If, at operation 535, the controller 234 determines that one or more interdependent devices require a software update then control passes back to operation 530 and the controller 234 receives and implements software updates for the interdependent devices. By contrast, if at operation 535 the controller 234 determines that there are no interdependent devices which require a software update then control passes to operation 560 and the controller 234 switches the execution pointer for the device to the newly installed software.

At operation 565 the controller 234 informs the gateway that the update is complete and performs an update of the anti-rollback counter. At operation 570 the controller 234 passes an update status message to the gateway. In some examples the status update message may indicate whether the rollback was a success or a failure.

By contrast, if at operation 525 the policy decision is to implement an offline update then the controller 234 executes operations 540-550 repeatedly until all interdependent devices have been updated. At operation 540 the controller 234 receives the software update and at operation 545 the controller 234 waits until an offline update is feasible to execute the update process on the target device. If, at operation 550, the controller 234 determines that one or more interdependent devices require a software update then control passes back to operation 540 and the controller 234 receives and implements software updates for the interdependent devices. By contrast, if at operation 550 the controller 234 determines that there are no interdependent devices which require a software update then control passes to operation 555 and the controller 234 waits until the target device(s) are reset before control passes to operations 560-570 are implemented.

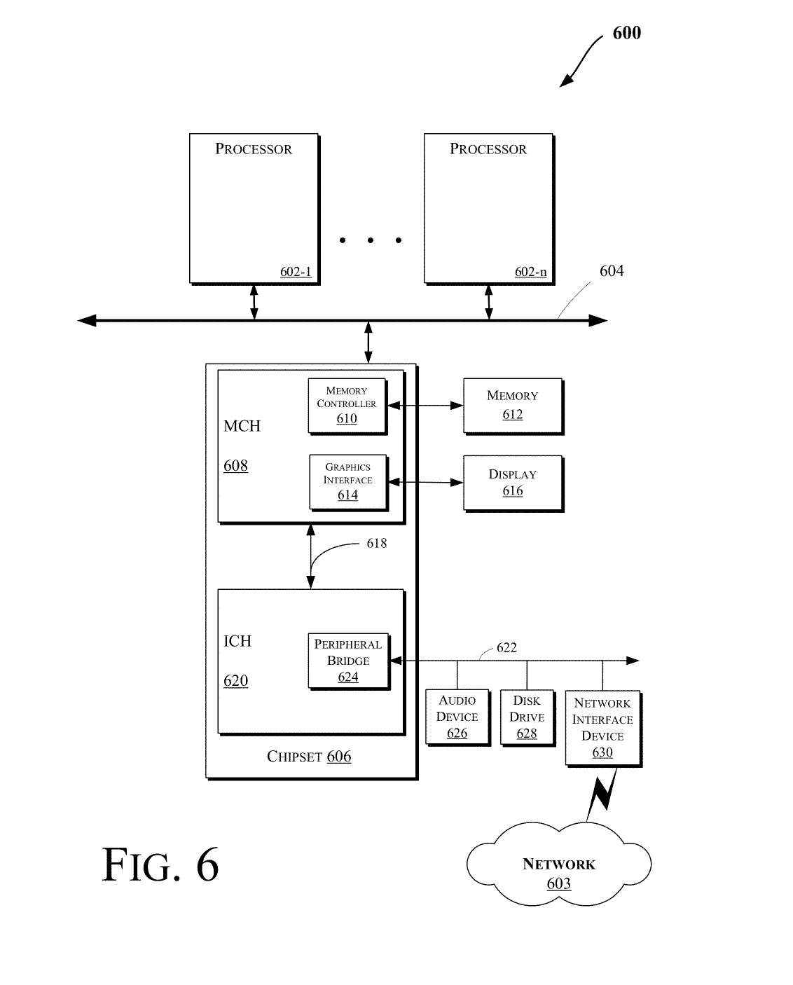

Thus, described herein are examples of a context-aware software update framework which may be used in autonomous vehicles. As described above, in some examples the controller 234 may be embodied as a computer system. FIG. 6 illustrates a block diagram of a computing system 600 in accordance with an example. The computing system 600 may include one or more central processing unit(s) 602 or processors that communicate via an interconnection network (or bus) 604. The processors 602 may include a general purpose processor, a network processor (that processes data communicated over a computer network 603), or other types of a processor (including a reduced instruction set computer (RISC) processor or a complex instruction set computer (CISC)). Moreover, the processors 602 may have a single or multiple core design. The processors 602 with a multiple core design may integrate different types of processor cores on the same integrated circuit (IC) die. Also, the processors 602 with a multiple core design may be implemented as symmetrical or asymmetrical multiprocessors.

A chipset 606 may also communicate with the interconnection network 604. The chipset 606 may include a memory control hub (MCH) 608. The MCH 608 may include a memory controller 610 that communicates with a memory 612. The memory 412 may store data, including sequences of instructions, that may be executed by the processor 602, or any other device included in the computing system 600. In one example, the memory 612 may include one or more volatile storage (or memory) devices such as random access memory (RAM), dynamic RAM (DRAM), synchronous DRAM (SDRAM), static RAM (SRAM), or other types of storage devices. Nonvolatile memory may also be utilized such as a hard disk. Additional devices may communicate via the interconnection network 604, such as multiple processor(s) and/or multiple system memories.

The MCH 608 may also include a graphics interface 614 that communicates with a display device 616. In one example, the graphics interface 614 may communicate with the display device 616 via an accelerated graphics port (AGP). In an example, the display 616 (such as a flat panel display) may communicate with the graphics interface 614 through, for example, a signal converter that translates a digital representation of an image stored in a storage device such as video memory or system memory into display signals that are interpreted and displayed by the display 616. The display signals produced by the display device may pass through various control devices before being interpreted by and subsequently displayed on the display 616.

A hub interface 618 may allow the MCH 608 and an input/output control hub (ICH) 620 to communicate. The ICH 620 may provide an interface to I/O device(s) that communicate with the computing system 600. The ICH 620 may communicate with a bus 622 through a peripheral bridge (or controller) 624, such as a peripheral component interconnect (PCI) bridge, a universal serial bus (USB) controller, or other types of peripheral bridges or controllers. The bridge 624 may provide a data path between the processor 602 and peripheral devices. Other types of topologies may be utilized. Also, multiple buses may communicate with the ICH 620, e.g., through multiple bridges or controllers. Moreover, other peripherals in communication with the ICH 620 may include, in various examples, integrated drive electronics (IDE) or small computer system interface (SCSI) hard drive(s), USB port(s), a keyboard, a mouse, parallel port(s), serial port(s), floppy disk drive(s), digital output support (e.g., digital video interface (DVI)), or other devices.

The bus 622 may communicate with an audio device 626, one or more disk drive(s) 628, and a network interface device 630 (which is in communication with the computer network 603). Other devices may communicate via the bus 622. Also, various components (such as the network interface device 630) may communicate with the MCH 608 in some examples. In addition, the processor 602 and one or more other components discussed herein may be combined to form a single chip (e.g., to provide a System on Chip (SOC)). Furthermore, the graphics accelerator 616 may be included within the MCH 608 in other examples.

Furthermore, the computing system 600 may include volatile and/or nonvolatile memory (or storage). For example, nonvolatile memory may include one or more of the following: read-only memory (ROM), programmable ROM (PROM), erasable PROM (EPROM), electrically EPROM (EEPROM), a disk drive (e.g., 628), a floppy disk, a compact disk ROM (CD-ROM), a digital versatile disk (DVD), flash memory, a magneto-optical disk, or other types of nonvolatile machine-readable media that are capable of storing electronic data (e.g., including instructions).

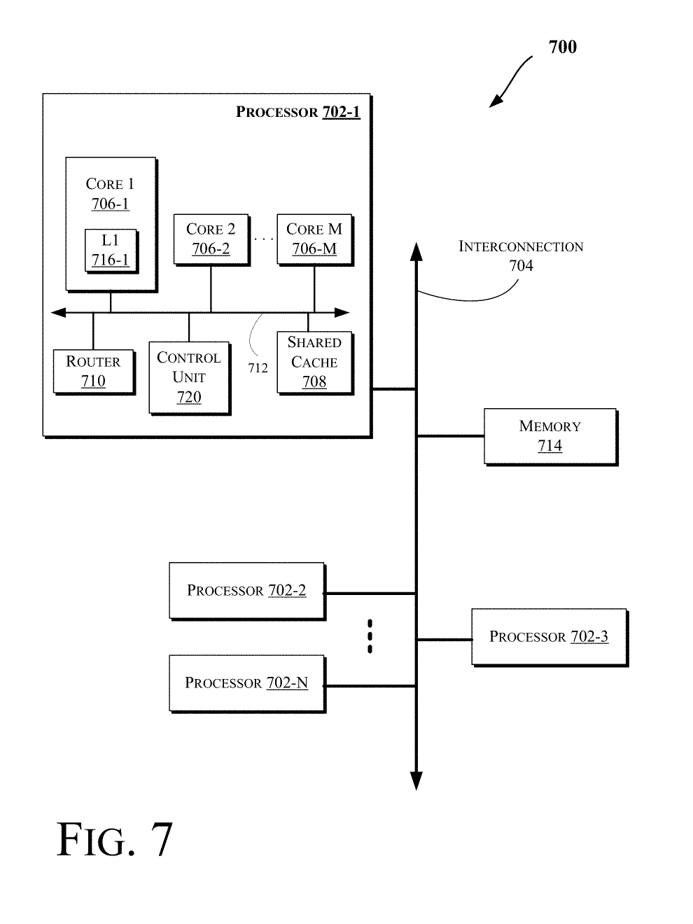

FIG. 7 illustrates a block diagram of a computing system 700, according to an example. The system 700 may include one or more processors 702-1 through 702-N (generally referred to herein as “processors 702” or “processor 702”). The processors 702 may communicate via an interconnection network or bus 704. Each processor may include various components some of which are only discussed with reference to processor 702-1 for clarity. Accordingly, each of the remaining processors 702-2 through 702-N may include the same or similar components discussed with reference to the processor 702-1.

In an example, the processor 702-1 may include one or more processor cores 706-1 through 706-M (referred to herein as “cores 706” or more generally as “core 706”), a shared cache 708, a router 710, and/or a processor control logic or unit 720. The processor cores 706 may be implemented on a single integrated circuit (IC) chip. Moreover, the chip may include one or more shared and/or private caches (such as cache 708), buses or interconnections (such as a bus or interconnection network 712), memory controllers, or other components.

In one example, the router 710 may be used to communicate between various components of the processor 702-1 and/or system 700. Moreover, the processor 702-1 may include more than one router 710. Furthermore, the multitude of routers 710 may be in communication to enable data routing between various components inside or outside of the processor 702-1.

The shared cache 708 may store data (e.g., including instructions) that are utilized by one or more components of the processor 702-1, such as the cores 706. For example, the shared cache 708 may locally cache data stored in a memory 714 for faster access by components of the processor 702. In an example, the cache 708 may include a mid-level cache (such as a level 2 (L2), a level 3 (L3), a level 4 (L4), or other levels of cache), a last level cache (LLC), and/or combinations thereof. Moreover, various components of the processor 702-1 may communicate with the shared cache 708 directly, through a bus (e.g., the bus 712), and/or a memory controller or hub. As shown in FIG. 7, in some examples, one or more of the cores 706 may include a level 1 (L1) cache 716-1 (generally referred to herein as “L1 cache 716”).

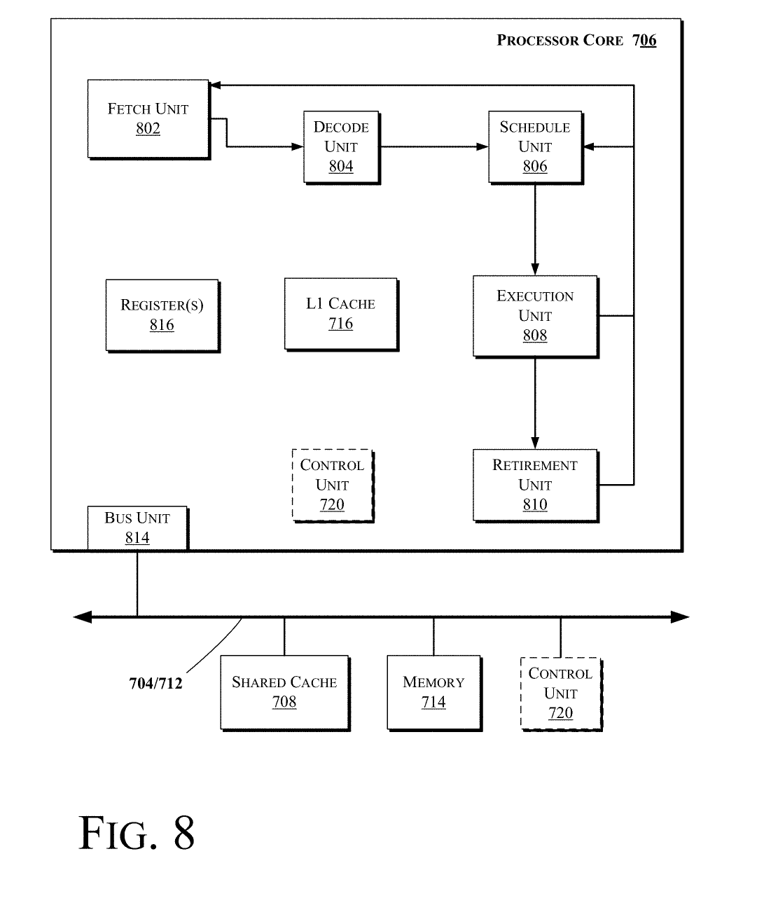

FIG. 8 illustrates a block diagram of portions of a processor core 706 and other components of a computing system, according to an example. In one example, the arrows shown in FIG. 8 illustrate the flow direction of instructions through the core 706. One or more processor cores (such as the processor core 706) may be implemented on a single integrated circuit chip (or die) such as discussed with reference to FIG. 7. Moreover, the chip may include one or more shared and/or private caches (e.g., cache 708 of FIG. 7), interconnections (e.g., interconnections 704 and/or 112 of FIG. 7), control units, memory controllers, or other components.

As illustrated in FIG. 8, the processor core 706 may include a fetch unit 802 to fetch instructions (including instructions with conditional branches) for execution by the core 706. The instructions may be fetched from any storage devices such as the memory 714. The core 706 may also include a decode unit 804 to decode the fetched instruction. For instance, the decode unit 804 may decode the fetched instruction into a plurality of uops (micro-operations).

Additionally, the core 706 may include a schedule unit 806. The schedule unit 806 may perform various operations associated with storing decoded instructions (e.g., received from the decode unit 804) until the instructions are ready for dispatch, e.g., until all source values of a decoded instruction become available. In one example, the schedule unit 806 may schedule and/or issue (or dispatch) decoded instructions to an execution unit 808 for execution. The execution unit 808 may execute the dispatched instructions after they are decoded (e.g., by the decode unit 804) and dispatched (e.g., by the schedule unit 806). In an example, the execution unit 808 may include more than one execution unit. The execution unit 808 may also perform various arithmetic operations such as addition, subtraction, multiplication, and/or division, and may include one or more an arithmetic logic units (ALUs). In an example, a co-processor (not shown) may perform various arithmetic operations in conjunction with the execution unit 808.

Further, the execution unit 808 may execute instructions out-of-order. Hence, the processor core 706 may be an out-of-order processor core in one example. The core 706 may also include a retirement unit 810. The retirement unit 810 may retire executed instructions after they are committed. In an example, retirement of the executed instructions may result in processor state being committed from the execution of the instructions, physical registers used by the instructions being de-allocated, etc.

The core 706 may also include a bus unit 714 to enable communication between components of the processor core 706 and other components (such as the components discussed with reference to FIG. 8) via one or more buses (e.g., buses 804 and/or 812). The core 706 may also include one or more registers 816 to store data accessed by various components of the core 706 (such as values related to power consumption state settings).

Furthermore, even though FIG. 7 illustrates the control unit 720 to be coupled to the core 706 via interconnect 812, in various examples the control unit 720 may be located elsewhere such as inside the core 706, coupled to the core via bus 704, etc.

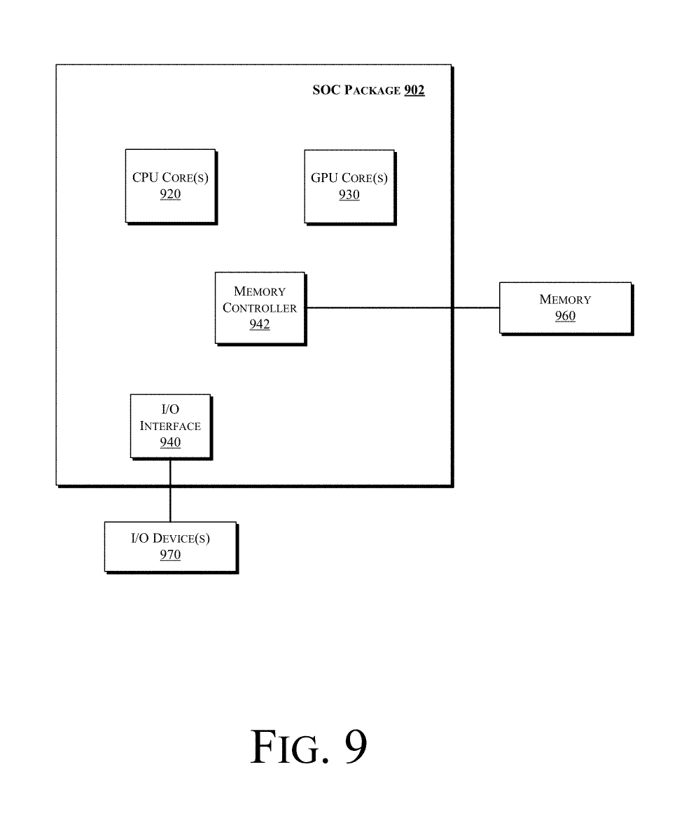

In some examples, one or more of the components discussed herein can be embodied as a System On Chip (SOC) device. FIG. 9 illustrates a block diagram of an SOC package in accordance with an example. As illustrated in FIG. 9, SOC 902 includes one or more processor cores 920, one or more graphics processor cores 930, an Input/Output (I/O) interface 940, and a memory controller 942. Various components of the SOC package 902 may be coupled to an interconnect or bus such as discussed herein with reference to the other figures. Also, the SOC package 902 may include more or less components, such as those discussed herein with reference to the other figures. Further, each component of the SOC package 902 may include one or more other components, e.g., as discussed with reference to the other figures herein. In one example, SOC package 902 (and its components) is provided on one or more Integrated Circuit (IC) die, e.g., which are packaged into a single semiconductor device.

As illustrated in FIG. 9, SOC package 902 is coupled to a memory 960 (which may be similar to or the same as memory discussed herein with reference to the other figures) via the memory controller 942. In an example, the memory 960 (or a portion of it) can be integrated on the SOC package 902.

The I/O interface 940 may be coupled to one or more I/O devices 970, e.g., via an interconnect and/or bus such as discussed herein with reference to other figures. I/O device(s) 970 may include one or more of a keyboard, a mouse, a touchpad, a display, an image/video capture device (such as a camera or camcorder/video recorder), a touch surface, a speaker, or the like.

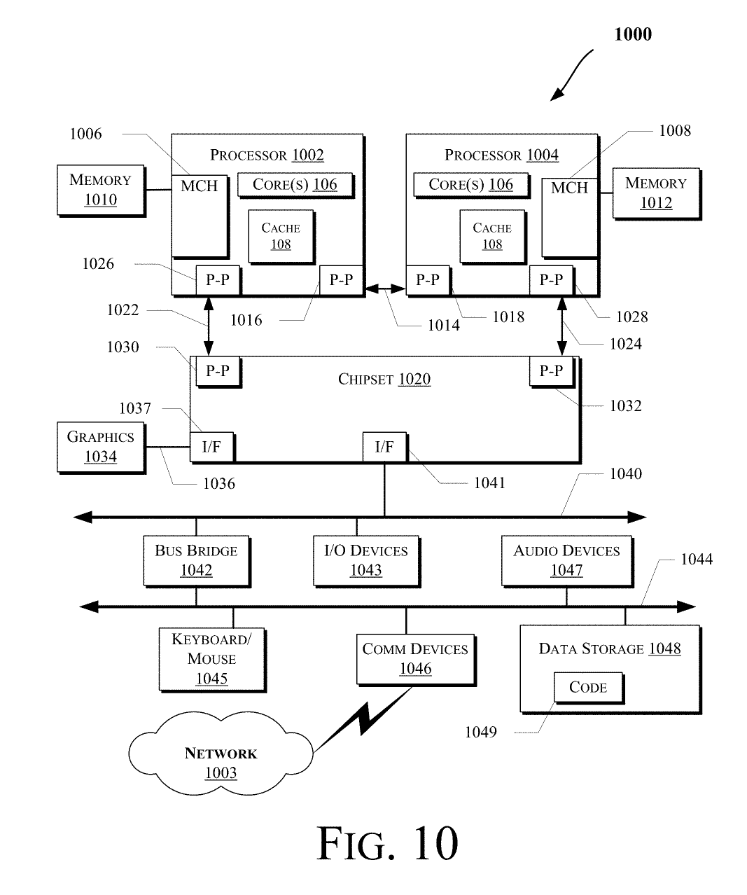

FIG. 10 illustrates a computing system 1000 that is arranged in a point-to-point (PtP) configuration, according to an example. In particular, FIG. 10 shows a system where processors, memory, and input/output devices are interconnected by a number of point-to-point interfaces. As illustrated in FIG. 10, the system 1000 may include several processors, of which only two, processors 1002 and 1004 are shown for clarity. The processors 1002 and 1004 may each include a local memory controller hub (MCH) 1006 and 1008 to enable communication with memories 1010 and 1012.

In an example, the processors 1002 and 1004 may be one of the processors 702 discussed with reference to FIG. 7. The processors 1002 and 1004 may exchange data via a point-to-point (PtP) interface 1014 using PtP interface circuits 1016 and 1018, respectively. Also, the processors 1002 and 1004 may each exchange data with a chipset 1020 via individual PtP interfaces 1022 and 1024 using point-to-point interface circuits 1026, 1028, 1030, and 1032. The chipset 1020 may further exchange data with a high-performance graphics circuit 1034 via a high-performance graphics interface 1036, e.g., using a PtP interface circuit 1037.

The chipset 1020 may communicate with a bus 1040 using a PtP interface circuit 1041. The bus 1040 may have one or more devices that communicate with it, such as a bus bridge 1042 and I/O devices 1043. Via a bus 1044, the bus bridge 1043 may communicate with other devices such as a keyboard/mouse 1045, communication devices 1046 (such as modems, network interface devices, or other communication devices that may communicate with the computer network 1003), audio I/O device, and/or a data storage device 1048. The data storage device 1048 (which may be a hard disk drive or a NAND flash based solid state drive) may store code 1049 that may be executed by the processors 1004.

The following examples pertain to further examples.

Example 1 is a system to manage software updates for one or more devices on a vehicle, comprising a communication interface to receive one or more software updates for the one or more devices on the vehicle; and a controller communicatively coupled to one or more devices and comprising processing circuitry to receive one or more software updates for at least one of the one or more devices; start a software update process for at least one of the one or more devices; detect a fault condition that corrupted the software update process; and in response to the fault condition, to implement a software update process fault protocol.

In Example 2, the subject matter of Example 1 can optionally include an arrangement in which the controller comprises processing circuitry to identify the at least one of the devices for which the software update process was corrupted; and retrieve an update policy for the at least one of the devices, wherein the update policy comprises an update attempt threshold.

In Example 3, the subject matter of any one of Examples 1-2 can optionally include an arrangement in which the controller comprises processing circuitry to restart the software update process repeatedly until the update attempt threshold is reached.

In Example 4, the subject matter of any one of Examples 1-3 can optionally include an arrangement in which the controller comprises processing circuitry to sample data from at least one of the plurality of sensors at a second sampling rate, different than the first sampling rate, in response to a determination that the electronic device is not in motion or is in a second predetermined location.

In Example 5, the subject matter of any one of Examples 1-4 can optionally include an arrangement wherein the controller comprises processing circuitry to rollback the software update process for the at least one of the devices.

Example 6 is a controller communicatively coupled to one or more devices and comprising processing circuitry to receive one or more software updates for at least one of the one or more devices; start a software update process for at least one of the one or more devices; detect a fault condition that corrupted the software update process; and in response to the fault condition, to implement a software update process fault protocol.

In Example 7, the subject matter of Example 6 can optionally include an arrangement in which the controller comprises processing circuitry to identify the at least one of the devices for which the software update process was corrupted; and retrieve an update policy for the at least one of the devices, wherein the update policy comprises an update attempt threshold.

In Example 8 the subject matter of any one of Examples 6-7 can optionally include an arrangement in which the controller comprises processing circuitry to restart the software update process repeatedly until the update attempt threshold is reached.

In Example 9, the subject matter of any one of Examples 6-8 can optionally include an arrangement in which the controller comprises processing circuitry to sample data from at least one of the plurality of sensors at a second sampling rate, different than the first sampling rate, in response to a determination that the electronic device is not in motion or is in a second predetermined location.

In Example 10, the subject matter of any one of Examples 6-9 can optionally include an arrangement wherein the controller comprises processing circuitry to rollback the software update process for the at least one of the devices.

Example 11 is a system to manage software updates for one or more devices on a vehicle, comprising a communication interface to receive one or more software updates for the one or more devices on the vehicle; and a controller communicatively coupled to the one or more devices and comprising processing circuitry to receive one or more software updates for at least one of the one or more devices; gather context data for the software updates for at least one of the one or more devices; determine whether the at least one of the one or more devices is interdependent with another device; and implement one of a real-time update process or an offline update process.

In Example 12, the subject matter of Example 11 can optionally include an arrangement the controller comprises processing circuitry to determine whether one or more devices which are interdependent with the at least one of the one or more devices requires a software update.

In Example 13, the subject matter of any one of Examples 11-12 can optionally include an arrangement wherein the controller comprises processing circuitry to initiate a software update process for the one or more devices which are interdependent with the at least one of the one or more devices.

In Example 14, the subject matter of any one of Examples 11-13 can optionally include an arrangement wherein the controller comprises processing circuitry to reset an executable pointer.

In Example 15, the subject matter of any one of Examples 11-14 can optionally include an arrangement wherein the controller comprises processing circuitry to reset the at least one of the one or more devices.

Example 16 is a controller comprising processing circuitry to to receive one or more software updates for at least one of the one or more devices; gather context data for the software updates for at least one of the one or more devices; determine whether the at least one of the one or more devices is interdependent with another device; and implement one of a real-time update process or an offline update process.

In Example 17, the subject matter of Example 16 can optionally include an arrangement the controller comprises processing circuitry to determine whether one or more devices which are interdependent with the at least one of the one or more devices requires a software update.

In Example 18, the subject matter of any one of Examples 16-17 can optionally include an arrangement wherein the controller comprises processing circuitry to initiate a software update process for the one or more devices which are interdependent with the at least one of the one or more devices.

In Example 19 the subject matter of any one of Examples 16-18 can optionally include an arrangement wherein the controller comprises processing circuitry to reset an executable pointer.

In Example 20, the subject matter of any one of Examples 16-19 can optionally include an arrangement wherein the controller comprises processing circuitry to reset the at least one of the one or more devices.

The terms “logic instructions” as referred to herein relates to expressions which may be understood by one or more machines for performing one or more logical operations. For example, logic instructions may comprise instructions which are interpretable by a processor compiler for executing one or more operations on one or more data objects. However, this is merely an example of machine-readable instructions and examples are not limited in this respect.

The terms “computer readable medium” as referred to herein relates to media capable of maintaining expressions which are perceivable by one or more machines. For example, a computer readable medium may comprise one or more storage devices for storing computer readable instructions or data. Such storage devices may comprise storage media such as, for example, optical, magnetic or semiconductor storage media. However, this is merely an example of a computer readable medium and examples are not limited in this respect.

The term “logic” as referred to herein relates to structure for performing one or more logical operations. For example, logic may comprise circuitry which provides one or more output signals based upon one or more input signals. Such circuitry may comprise a finite state machine which receives a digital input and provides a digital output, or circuitry which provides one or more analog output signals in response to one or more analog input signals. Such circuitry may be provided in an application specific integrated circuit (ASIC) or field programmable gate array (FPGA). Also, logic may comprise machine-readable instructions stored in a memory in combination with processing circuitry to execute such machine-readable instructions. However, these are merely examples of structures which may provide logic and examples are not limited in this respect.

Some of the methods described herein may be embodied as logic instructions on a computer-readable medium. When executed on a processor, the logic instructions cause a processor to be programmed as a special-purpose machine that implements the described methods. The processor, when configured by the logic instructions to execute the methods described herein, constitutes structure for performing the described methods. Alternatively, the methods described herein may be reduced to logic on, e.g., a field programmable gate array (FPGA), an application specific integrated circuit (ASIC) or the like.

In the description and claims, the terms coupled and connected, along with their derivatives, may be used. In particular examples, connected may be used to indicate that two or more elements are in direct physical or electrical contact with each other. Coupled may mean that two or more elements are in direct physical or electrical contact. However, coupled may also mean that two or more elements may not be in direct contact with each other, but yet may still cooperate or interact with each other.

Reference in the specification to “one example” or “some examples” means that a particular feature, structure, or characteristic described in connection with the example is included in at least an implementation. The appearances of the phrase “in one example” in various places in the specification may or may not be all referring to the same example.

Although examples have been described in language specific to structural features and/or methodological acts, it is to be understood that claimed subject matter may not be limited to the specific features or acts described. Rather, the specific features and acts are disclosed as sample forms of implementing the claimed subject matter.

What is claimed is:

1. A system to manage software updates for one or more devices on a vehicle, comprising:
a communication interface to receive one or more software updates for the one or more devices on the vehicle; and
a controller communicatively coupled to one or more devices and comprising processing circuitry to:
receive one or more software updates for at least one of the one or more devices;
start a software update process for at least one of the one or more devices;
detect a fault condition that corrupted the software update process; and
in response to the fault condition, to implement a software update process fault protocol.

2. The system of claim 1, wherein the controller comprises processing circuitry to:
identify the at least one of the devices for which the software update process was corrupted; and
retrieve an update policy for the at least one of the devices, wherein the update policy comprises an update attempt threshold.

3. The system of claim 2, wherein the controller comprises processing circuitry to restart the software update process repeatedly until the update attempt threshold is reached.

4. The system of claim 2, wherein the controller comprises processing circuitry to rollback the software update process for the at least one of the devices.

5. The system of claim 4, wherein the controller comprises processing circuitry to rollback any software update processes for any devices which are interdependent with the at least one of the devices.

6. A controller comprising processing circuitry to:
receive one or more software updates for at least one device communicatively coupled to the controller;
start a software update process for the at least one device;
detect a fault condition that corrupted the software update process; and
in response to the fault condition, to implement a software update process fault protocol.

7. The controller of claim 6, further comprising processing circuitry to:
identify the at least one device for which the software update process was corrupted; and
retrieve an update policy for the at least one device, wherein the update policy comprises an update attempt threshold.

8. The controller of claim 7, further comprising processing circuitry to restart the software update process repeatedly until the update attempt threshold is reached.

9. The controller of claim 6, further comprising processing circuitry to rollback the software update process for the at least one device.

10. The controller of claim 9, further comprising processing circuitry to rollback any software update processes for any devices which are interdependent with the at least one device.

11. A system to manage software updates for one or more devices on a vehicle, comprising:
a communication interface to receive one or more software updates for the one or more devices on the vehicle; and
a controller communicatively coupled to the one or more devices and comprising processing circuitry to:
receive one or more software updates for at least one of the one or more devices;
gather context data for the software updates for at least one of the one or more devices;
determine whether the at least one of the one or more devices is interdependent with another device; and
implement one of a real-time update process or an offline update process.

12. The system of claim 11, wherein the controller comprises processing circuitry to:
determine whether one or more devices which are interdependent with the at least one of the one or more devices requires a software update.

13. The system of claim 12, wherein the controller comprises processing circuitry to initiate a software update process for the one or more devices which are interdependent with the at least one of the one or more devices.

14. The electronic device of claim 12, wherein the controller comprises processing circuitry to reset an executable pointer.

15. The electronic device of claim 14, wherein the controller comprises processing circuitry to reset the at least one of the one or more devices.

16. A controller comprising processing circuitry to:
receive one or more software updates for at least one device communicatively coupled to the controller;
gather context data for the software updates for at least one device;
determine whether the at least one device is interdependent with another device; and
implement one of a real-time update process or an offline update process for the at least one device.

17. The controller of claim 16, further comprising processing circuitry to:
determine whether one or more devices which are interdependent with the at least one device which requires a software update.

18. The controller of claim 17, further comprising processing circuitry to initiate a software update process for the one or more devices which are interdependent with the at least one device which requires a software update.

19. The controller of claim 18, further comprising processing circuitry to reset an executable pointer.

20. The controller of claim 19, further comprising processing circuitry to reset the at least one device.
